(19) United States
(12) Patent Application Publication
(10) Pub. No.: US 2018/0218444 A1
(43) Pub. Date: Aug. 2, 2018

(54) Method And Platform For Matching Buy And Sell Orders

(71) Applicant: OpenDoor Securities, LLC, Jersey City, NJ (US)

(72) Inventors: Christopher C. Ferreri, Staten Island, NY (US); Michael Sacks, New York, NY (US)

(21) Appl. No.: 15/884,352

(22) Filed: Jan. 30, 2018

Related U.S. Application Data
(63) Continuation-in-part of application No. PCT/US2017/014463, filed on Jan. 20, 2017.
(60) Provisional application No. 62/452,977, filed on Jan. 31, 2017.

(51) Int. Cl. G06Q 30/08; G06Q 40/02; G06F 17/17

(52) U.S. Cl. CPC G06Q 30/08; G06F 17/17; G06Q 40/02

(57) ABSTRACT

A computer-implemented method and platform enable a multi-phase, call auction for at least one asset. The method includes initiating the auction for at least one asset; conducting a pricing phase for a first period of time; calculating and publishing at least one calibrated mid-price curve for the asset(s); conducting a breathing phase for a second period of time, during which participants can evaluate the calibrated mid-price curve; conducting a matching phase for a third period of time; receiving at least one buy order and at least one sell order; and attempting to match one or more of the buy order(s) and one or more of the sell order(s). Buy order(s) and sell order(s) are anonymously matched and filled. During the matching phase, market gap(s) between or among orders are identified, and KeyChain orders to fill the market gaps are generated.

### CROSS-REFERENCE TO RELATED APPLICATION(S)

This application is related to and claims priority benefits from U.S. provisional patent application Ser. No. 62/452,977 filed on Jan. 31, 2017, entitled “Method and Platform for Matching Buy and Sell Orders”. This application is also a continuation-in-part of international application No. PCT/US2017/014463 filed on Jan. 20, 2017, also entitled “Method and Platform for Matching Buy and Sell Orders”. Each of the '977 provisional and '463 international applications is hereby incorporated by reference herein in its entirety.

### FIELD OF THE INVENTION

The present invention involves matching buy and sell orders, identifying market gaps, generating orders to fill those gaps and trading assets between or among two or more participants. In many of the embodiments, the assets are traded anonymously. The present invention applies to financial assets, including, but not limited to, U.S. Treasuries and other financial instruments. The present invention also applies to non-financial assets, including, but not limited to, event tickets, art, vehicles and collectables.

### BACKGROUND OF THE INVENTION

Executing a transaction in a market typically depends on matching a buyer and a seller, or a buy order and a sell order, as to, for example, asset, price and amount. For a fungible asset, efficiently matching a buyer and seller or their respective orders, and realizing the asset's liquidity, is a relatively common occurrence. However, for an illiquid asset, or asset of lower liquidity, efficiently matching a buyer and seller or their respective orders, and unlocking liquidity, is more challenging.

### SUMMARY OF THE INVENTION

Shortcomings of existing techniques for matching buy and sell orders are overcome by the method and platform described herein, through which orders involving at least one asset, which can be of one or more types and/or from one or more sectors and from various participants (buyers, sellers, buyers/sellers and sellers/buyers), are efficiently matched. The present method and platform efficiently facilitate trades and unlock liquidity of markets, assets or both by reducing one or more transaction costs, including time, money and effort, typically associated with traditional price/time priority techniques for matching buy and sell orders. In some embodiments, the present method and platform efficiently facilitate trades and unlock liquidity of markets, assets or both by identifying one or more market gaps, generating one or more live, executable, non-negotiable orders to fill one or more of the market gaps and filling orders.

A computer-implemented method enables an anonymous, multi-phase, call auction of at least one asset. The method comprises:
(a) initiating the auction for the at least one asset;
(b) conducting a pricing phase for a first period of time;
(c) calculating and publishing at least one calibrated mid-price curve for the at least one asset;
(d) conducting a breathing phase for a second period of time, during which one or more participants can evaluate the at least one calibrated mid-price curve;
(e) conducting a matching phase for a third period of time;
(f) receiving at least one buy order and at least one sell order; and
(g) attempting to match one or more of the at least one buy order and one or more of the at least one sell order.

In some embodiments, the foregoing method further comprises anonymously matching and at least partially filling one or more of the at least one buy order and one or more of the at least one sell order.

In some embodiments, the method further comprises:
(h) during the matching phase, identifying one or more market gaps between or among two or more orders;
(i) generating one or more KeyChain orders to fill one or more of the one or more market gaps;
(j) forming a KeyChain of three or more orders, where one or more of the orders are the one or more KeyChain orders and two or more of the orders are participant-entered orders; and
(k) at least partially filling an amount of each of the three or more orders in the KeyChain, thereby completing the KeyChain.

In some embodiments, the method further comprises:
(h) calculating and publishing at least one pre-calibrated mid-price curve for the at least one asset.

In some embodiments of the method, the at least one buy order and the at least one sell order are entered during the breathing phase and each order is assigned a unique, random time-stamp at or near the end of the breathing phase.

In some embodiments of the method, the at least one buy order and the at least one sell order are submitted substantially simultaneously at or near the outset of the matching phase.

In some embodiments of the method, the at least one asset comprises one from the group of U.S. Treasuries and other bonds.

In some embodiments of the method, the at least one asset spans multiple sectors.

In some embodiments of the method, the matching phase lasts for at least 3 minutes and ends 30 seconds after a last new order is entered.

In some embodiments, the method further comprises:
(h) a last call phase.

In some embodiments, the method further comprises:
(h) an odd lot cleanup phase.

In some embodiments of the method, pennying by one or more participants is mitigated.

In some embodiments of the method, the pricing phase includes:
(i) evaluating and
(ii) accepting or rejecting a level that a participant contributes to calibrate the calibrated mid-price curve.

In some embodiments of the method, any order entered is prioritized based on price/time priority.

In some embodiments of the method, the matching phase involves performing a credit check on a participant prior to matching any order entered by the participant.

In some embodiments of the method, orders are attempted to be matched continuously during the matching phase and a notification of an at least partially filled order is provided in real-time to each corresponding participant.

In some embodiments of the method, each order is filled at a displayed price or at an updated price more favorable to the participant that entered the order.

In some embodiments, the method further comprises:
(h) determining whether there is sufficient participant interest for the auction of the at least one asset.

In some embodiments of the method, the auction is all-to-all.

A computer-implemented method enables an anonymous, multi-phase, call auction of at least one non-financial asset, the method comprising:
(a) initiating the auction for the at least one asset;
(b) conducting a pricing phase for a first period of time;
(c) calculating and publishing at least one calibrated mid for the at least one asset;
(d) conducting a breathing phase for a second period of time, during which one or more participants can evaluate the at least one calibrated mid;
(e) conducting a matching phase for a third period of time;
(f) receiving at least one buy order and at least one sell order; and
(g) attempting to match one or more of the at least one buy order and one or more of the at least one sell order.

Some embodiments of the foregoing method further comprise anonymously matching and at least partially filling one or more of the at least one buy order and one or more of the at least one sell order.

In some embodiments, the method further comprises:
(h) during the matching phase, identifying one or more market gaps between or among two or more orders;
(i) generating one or more KeyChain orders to fill one or more of the one or more market gaps;
(j) forming a KeyChain of three or more orders, where one or more of the orders are the one or more KeyChain orders and two or more of the orders are participant-entered orders; and
(k) at least partially filling an amount of each of the three or more orders in the KeyChain, thereby completing the KeyChain.

In some embodiments of the method, the at least one non-financial asset is at least one of artwork, jewelry, a vehicle, currency, furniture, ceramic, clothing, an event ticket, or a collectable item. The collectable item can include a sports card or an autograph.

### BACKGROUND AND TERMINOLOGY

During a session, which is a period of time, a call auction can be held. A call auction is an auction in which two or more participants enter, or stage, one or more buy or sell orders. That is, a participant selects (1) a side (buy or sell), where a side is also known as a direction, (2) an asset, including, for example, a particular financial instrument or issue, (3) an amount, or size, of an order and (4) a price; that is, a level, yield or yield spread, where the level, yield or yield spread can be below, at or above a calibrated mid-market level, which is also known as a calibrated mid-price or calibrated mid. A mid is an average, or mean, price, yield or yield spread for an asset. For some assets, such as financial assets, corresponding mids can be mapped to the maturities of the assets to form mid-price curves, such as, for example, U.S. Treasury yield curves. As participants enter buy and sell orders and the call auction proceeds, attempts to match orders can be made, orders can be matched and filled and liquidity in one or more markets and/or one or more assets can be unlocked. During the call auction, liquidity also can be unlocked by live, executable, non-negotiable orders that are generated. During the call auction, liquidity also can be unlocked by a trade at a mid rule; that is, for a buy order at a price below (that is, behind) a calibrated mid, a certain amount of the asset at the mid is automatically included in the order.

### BRIEF DESCRIPTION OF THE DRAWINGS

FIG. 1 is a flow diagram illustrating an exemplary method of matching buy and sell orders that traditionally would not be matched or not be matched as efficiently.

FIG. 2A is a flow diagram illustrating an exemplary Mid-Calibrating Algorithm.

FIG. 2B is a flow diagram illustrating an exemplary Mid-Calibrating Algorithm with exemplary price data sources.

FIG. 3 is a flow diagram illustrating an exemplary KeyChain.

FIG. 4 is an illustrative screenshot of a Pricing Phase Menu as seen on an exemplary platform.

FIG. 5 is an illustrative screenshot of a Breathing Phase Menu as seen on an exemplary platform.

FIG. 6 is an illustrative screenshot of a Matching Phase Menu as seen on an exemplary platform.

FIG. 7 is an illustrative screenshot of an Order Book as seen on an exemplary platform.

FIG. 8 is an illustrative screenshot of a KeyChain order (that is, an illustrative screenshot of a live, executable, non-negotiable order) as seen on an exemplary platform.

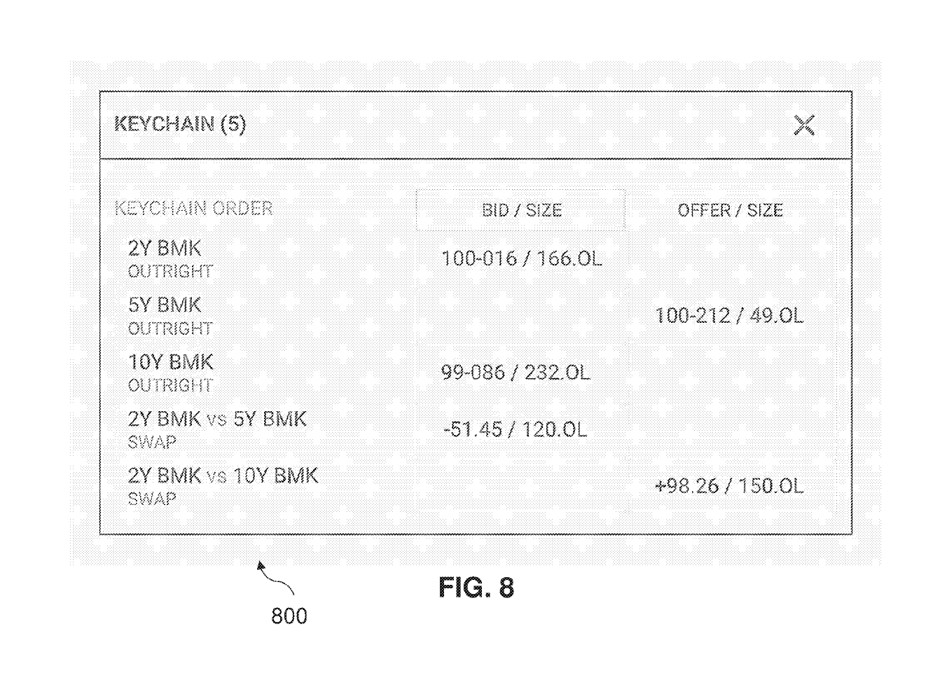

### DETAILED DESCRIPTION OF ILLUSTRATIVE EMBODIMENTS

A method and platform for anonymously matching buy and sell orders that are not limited to a single type of asset can include a call auction of one or more types of assets, such as, but not limited to:
(a) U.S. Treasuries, namely, (i) bills, (ii) notes, (iii) bonds and (iv) Treasury Inflation-Protected Securities (TIPS), including:
   (A) Off-the-run Treasuries (OFTRs); and
   (B) On-the-run Treasuries (OTRs);
(b) other bonds, including, but not limited to,
   (i) municipal bonds; and
   (ii) corporate bonds;
   (c) Non-financial assets that do not or may not have readily identifiable prices or a readily identifiable market, but may have some relationship, for example, as to asset type, including but not limited to artwork, jewelry, a vehicle, currency, furniture, ceramic, clothing, an event ticket, or a collectable item such as, for example, a sports card or an autograph.

The method and platform are configured such that participants' identities, trading strategies or both can be anonymous, meaning not compromised in connection with the method or platform.

In some embodiments, assets can be identified by type and/or sector. Sectors can consist of assets grouped by maturity. U.S. Treasuries can be grouped in, for example, 2-year, 3-year, 5-year, 7-year, 10-year and 30-year sectors. TIPS can be grouped in, for example, 5-year, 10-year and 30-year sectors.

The present method and platform can unlock liquidity in an illiquid or low-liquidity asset, or eliminate or reduce an asset's illiquidity, by identifying one or more market gaps, which arise where a buy order lacks a matching sell order or vice versa. A buy order is an order with a buy component. A sell order is an order with a sell component. The present method and platform can combine two or more orders, which can be a combination of one or more swap orders (swaps) and one or more outright orders, or a combination of two or more swaps, to generate one or more live, executable, non-negotiable orders to fill one or more market gaps. A swap is an order where an asset is to be traded, switched or exchanged for another asset according to certain criteria, such as one or more of asset type, price and amount. A swap is also known as a switch. A swap can be, for example, a buy/sell order or a sell/buy order. An outright order is an order that involves an asset to be traded or exchanged outright on price or yield. For example, an order can be an outright buy order or an outright sell order. An outright order is not a swap or hedge. A hedge is a contingent transaction of an asset that involves taking an offsetting position in a related asset. Yield is an amount of return realized on an investment.

In some embodiments, the orders are combined according to price/time priority, which is described below. In some embodiments, amount, or size, of an order has no priority.

Generating one or more live, executable, non-negotiable orders forms a KeyChain. A KeyChain is a chain of completable orders or a chain of at least partially completable orders. A KeyChain is completed if each order in a KeyChain is at least partially completed (that is, at least partially filled as to amount). A KeyChain includes three or more orders, where one or more orders are buy orders and one or more orders are sell orders. One or more of the orders in a KeyChain are generated orders, which are also known as “KeyChain orders,” and two or more of the orders in a KeyChain are participant-entered orders. Each KeyChain order that is executed and completed or partially completed (that is, filled or partially filled as to amount) fills or partially fills, respectively, a market gap and unlocks liquidity, or eliminates or reduces illiquidity, in one or more markets and/or one or more assets. Each participant-entered order that is executed and completed or partially completed (that is, filled or partially filled as to amount) directly or indirectly because of the executed and completed or partially completed KeyChain order results in unlocked liquidity, or elimination or reduction of illiquidity, in one or more markets and/or one or more assets.

In some preferred embodiments, orders (that is, participant-entered orders and KeyChain orders) are anonymous, meaning a participant cannot view another participant's identity, another participant's trading strategy (that is, another participant's orders or order book) or the total volume of any asset traded, even if the participant is involved in a completed trade for that asset. An anonymous order does not compromise the identity of a participant entering or executing an order, including a participant who enters or executes the order as a counterparty to a trade. In some preferred embodiments, during a call auction, a participant cannot view any part of any other participant's order book. In some preferred embodiments, after a call auction has ended, a participant cannot view the size of any other participant's order imbalance. In some embodiments, participant identity and other trade information are not compromised even after a call auction has ended.

In some embodiments, the method and platform include determining whether to hold a call auction. In some embodiments, such a determination is made by assessing whether there is sufficient participant interest in one or more assets to be auctioned. In some embodiments, if there is sufficient interest in at least one asset, then a call auction will be held; if there is not sufficient interest in at least one asset, then a call auction will not be held.

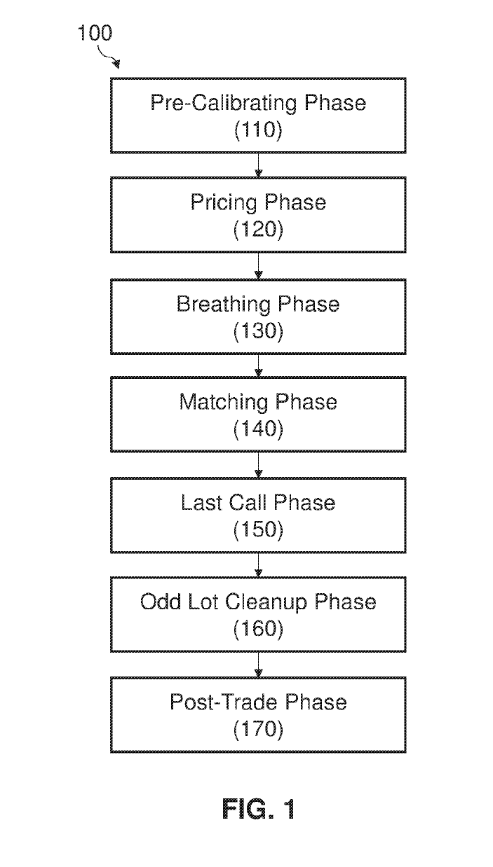

FIG. 1 is a flow diagram illustrating an exemplary embodiment of the present method for matching buy and sell orders. Method 100 is a call auction of assets. In some embodiments, method 100 is multi-phase. In some embodiments, method 100 can include, but is not limited to, one or more of a Pre-Calibrating Phase 110, a Pricing Phase 120, a Breathing Phase 130, a Matching Phase 140, a Last Call Phase 150, an Odd Lot Cleanup Phase 160, and a Post-Trade Phase 170.

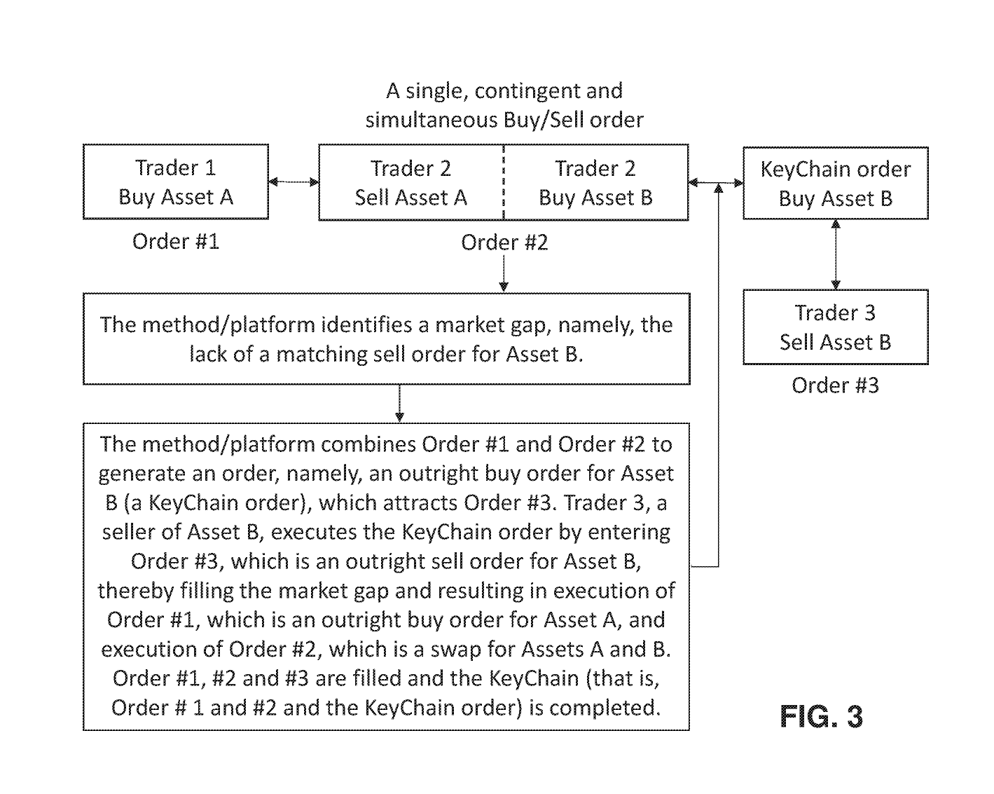

FIG. 3 is a flow diagram illustrating an exemplary KeyChain. As illustrated, a participant, namely, Trader 1, enters Order #1, which is an outright buy order for Asset A. A second participant, namely, Trader 2, enters Order #2, which is a swap, namely, a single, contingent and simultaneous buy and sell (that is, buy/sell) order to sell Asset A and buy Asset B. The method identifies a market gap, namely, the lack of a matching sell order for Asset B. The method combines Order #1 and Order #2 to generate an order, namely, an outright buy order for Asset B. The outright buy order for Asset B is a KeyChain order. The KeyChain order is published in order to attract a participant for Order #3. The published KeyChain order specifies the asset (here, Asset B), price, direction (here, buy) and amount to fill the market gap. The KeyChain order is a live, executable, non-negotiable order. The KeyChain order attracts Order #3. That is, a third participant, Trader 3, executes the KeyChain order by entering Order #3, which is an outright sell order for Asset B, thereby filling the market gap and resulting in execution of Order #1 and Order #2. Order #1, #2 and #3 are filled (that is, each Order is at least partially filled as to amount) and the KeyChain is completed.

### Pricing Phase

Pricing Phase 120 can be used to calibrate a mid for use during a call auction.

In some embodiments, at or near the end of Pricing Phase 120, a mid-price curve, which is also known as a mid curve, is calibrated through Mid-Calibrating Algorithm 210.

In some embodiments, Mid-Calibrating Algorithm 210 involves a Tabulating Step 212, an Averaging Step 214 and a Calibrating Step 216.

In some embodiments, Tabulating Step 212 involves tabulating, or collecting, any buy prices and sell prices contributed, or fed, by any sponsors; any buy prices and sell prices contributed, or fed, by any vendors (that is, independent, third parties, such as price data, or market data, vendors); and any buy prices and sell prices contributed by any participants. Typically, Tabulating Step 212 will involve tabulating prices from at least one or more sponsors and one or more vendors.

In some embodiments, Averaging Step 214 involves calculating an arithmetic, or Olympic, average by eliminating a percentage of high and low participant prices and then averaging remaining and accepted sponsor-contributed, or sponsor-fed, prices, vendor-contributed, or vendor-fed, prices and participant-contributed prices. In some embodiments, Averaging Step 214 involves calculating merely the mean of accepted sponsor-contributed prices, vendor-contributed prices and participant-contributed prices.

In some embodiments, participants include institutional investors, traders and dealers. In some of the same embodiments, sponsors also can be participants. In some embodiments, sponsor membership enables end-user access to the platform. An end-user can be, for example, a professional, institutional trader at a hedge fund, a regional bank, an asset manager, a pension fund, a central bank or an insurance company.

In some embodiments, Calibrating Step 216 includes calibrating an average or mean from Averaging Step 214 based on prior auction, or prior session, data.

Mid-Calibrating Algorithm 210 is designed to produce a robust mid, even where no participant contributes a price during Pricing Phase 120. That is, a participant can, but is not obligated to, contribute one or more prices during Pricing Phase 120. A robust mid is more likely to result in a mutually acceptable price to a buyer and seller during Matching Phase 140.

In some embodiments, the mid calibrated by Mid-Calibrating Algorithm 210 is not displayed to any participant prior to Breathing Phase 130.

In some preferred embodiments, Pricing Phase 120 is confidential such that a participant is not shown any pre-calibrated mid, or mid-price curve, or any level contributed by any other participant.

In some embodiments, during Pricing Phase 120, prices are updated after a certain time period. In some embodiments, the time period is an hour. In some embodiments, the time period is a minute. In some preferred embodiments, the time period is a second. In some embodiments, the time period is designed to enhance actual or potential liquidity of one or more markets and/or one or more assets.

In some embodiments, participants submit prices during Pricing Phase 120 via electronic feed or directly into a call auction. In some embodiments, a participant's submission of one or more prices has no bearing on any order or potential to be matched during Matching Phase 140.

In some embodiments, a pre-calibrated mid is calculated in Pre-Calibrating Phase 110, which is prior to Pricing Phase 120. The pre-calibrated mid can enable more efficient discarding of out-of-band, or out-of-range, prices that participants may submit during Pricing Phase 120. For example, in some embodiments, if the difference between a participant's submitted price and the pre-calibrated mid exceeds a configurable or predetermined tolerance, then the participant's price is out-of-range and discarded when the mid is calibrated during Pricing Phase 120. Such discarding can improve the robustness of the calibrated mid. In some embodiments, the participant is not notified that a submitted price has been discarded. In other embodiments, the participant is notified that a submitted price has been discarded.

In some embodiments, the algorithm to determine the pre-calibrated mid is Mid-Calibrating Algorithm 210, except that prices used to determine a pre-calibrated mid are sponsor-contributed prices and/or vendor-contributed prices. Participant-contributed process are not used to determine a pre-calibrated mid. In some embodiments, if no participant contributes a level during Pricing Phase 120, then the pre-calibrated mid and calibrated mid are identical.

In some embodiments, a participant can view a calibrated mid, but the participant cannot view a sponsor's contributed level or another participant's contributed level. In some embodiments, a sponsor cannot view a level contributed by another sponsor.

Pricing Phase 120 can include calculation, calibration and publication of one or more robust mids, or mid-price curves, for one or more corresponding assets in a call auction.

### Breathing Phase

In some embodiments, Breathing Phase 130 follows Pricing Phase 120. Breathing Phase 130 can include, among other things, an opportunity for a participant to pause and evaluate one or more published mids.

In some embodiments, Breathing Phase 130 can involve participants entering one or more orders prior to Matching Phase 140. During Breathing Phase 130, a participant can enter one or more swaps, one or more outright buy or sell orders or a combination of one or more swaps and one or more outright buy or sell orders.

In some embodiments, a participant can originate (1) an outright, OFTR order on (a) price, in 32nds, or (b) yield, not tied to a sector benchmark, which is also known as a sector OTR, (2) a swap involving an OFTR, which can be entered in a yield spread tied to (a) the sector benchmark, which is also known as the sector OTR (for example, buy the OFTR and sell a duration-weighted amount of the OTR), (b) an alternative sector benchmark, which is also known as an alternative sector OTR, or (c) another OFTR (for example, buy one OFTR and sell a duration-weighted amount of another OFTR).

A duration-weighted amount is the amount of an asset necessary to balance a swap or hedge. A yield spread is the difference between the quoted rates of return on two different investments, usually of different credit quality. A yield spread is often an indication of a risk premium for investing in one asset over another. A yield spread is also known as a credit spread.

In some embodiments, orders entered during Breathing Phase 130 can be restricted by a minimum fill constraint or requirement.

In some embodiments, an anchor leg of a swap, which is the leg, or asset, for which a participant has selected an amount, can have a minimum fill constraint. In the same or other embodiments, no leg of a swap can have a minimum increment constraint.

In some embodiments, the participant can select a second leg, or asset, in a swap by entering one or more criteria for the second asset, such as a particular issue. In some embodiments, the participant is presented with assets having the one or more criteria. Often, that information is viewable on a screen. The participant can then select the second asset, determine its direction (that is, buy or sell), and the method can snap, or capture, a corresponding mid. In some embodiments, the participant then can select and confirm the price, yield or yield spread, that is, the difference in price, yield or yield spread value for the second, or hedged, asset, and can view a calculated duration-weighted amount for the second asset. The participant then can submit and confirm its order.

In some embodiments, method 100 allows various buyers and sellers to originate orders during Breathing Phase 130, Matching Phase 140 or both Phases. A buyer or seller may originate the same types of orders described above during either or both of those Phases.

In some embodiments, two-legged swaps can be executed, as can butterfly or three-legged swaps.

In some embodiments, orders entered during Breathing Phase 130 receive unique, random time-stamps prior to Matching Phase 140. Such time-stamps are random to remove any advantage to being “first in” or earlier in time with an order during Breathing Phase 130. Such an advantage otherwise could result from, for example, an order that is entered by a faster typist or through a faster internet connection.

In some embodiments, once an order is entered, a participant's order book is updated with various order details.

### Matching Phase

At or near the outset of Matching Phase 140, orders previously entered, such as those entered during Breathing Phase 130, are submitted. In some embodiments, some or all previously entered orders are submitted substantially simultaneously.

Matching Phase 140 includes a matching engine that attempts to match and matches orders. A matching engine can embody a matching algorithm. A matching algorithm includes one or more matching rules or criteria, including, for example, price/time priority.

During Matching Phase 140, one or more orders may not be matched. The present method can solve that problem. In some embodiments, during Matching Phase 140, the present method identifies one or more market gaps, which arise where a buy order lacks a matching sell order or vice versa. In some embodiments, the present method then combines two or more orders, which can be (a) one or more swaps and one or more outright orders or (b) two or more swaps, to generate one or more KeyChain orders, which are live, executable, non-negotiable orders to fill one or more of the market gaps. In some embodiments, the two or more orders are combined according to price/time priority. Generating the one or more KeyChain orders forms a KeyChain that includes three or more orders, where one or more orders are buy orders and one or more orders are sell orders, as described above.

A KeyChain can include orders for one or more asset types, such as, for example, one or more U.S. Treasuries, namely, bill, notes, bonds and TIPS, including OFTRs and OTRs.

In some embodiments, a KeyChain order does not have a minimum fill or minimum increment constraint. Typically, a round lot is the minimum amount of an asset that can be traded as part of a KeyChain order or participant-entered order. However, in an effort to complete a KeyChain, an amount for a KeyChain order can be an odd lot, which is an amount other than a round lot.

In some embodiments, a KeyChain order for an odd lot is calculated to the round lot or other configurable or predetermined amount and a partial order for less, but not more, than the published bid or offer amount is allowed. In other words, when a participant hits (sells) or lifts (buys) a KeyChain bid or offer, the participant will be notified, for example, via a pop-up message, to specify an amount of an order, but not a price. A participant can specify an amount up to the full, published amount, and the order can be filled up to the amount entered.

An odd lot of an OTR is adjusted to produce a duration-weighted round lot of an OFTR in order to further enhance liquidity of the OFTR. A KeyChain order that is a yield spread order is duration-weighted to the corresponding sector benchmark.

As described above, each KeyChain order is non-negotiable, which means the price of the order cannot be negotiated or countered. Stated differently, a KeyChain order is not a participant-entered order, which can be negotiated or countered as to, for example, price. A participant-entered order is also known as a resting order. For a KeyChain order, a participant can either sell a bid or buy an offer, but it cannot negotiate or counter a price of a KeyChain order.

In some embodiments, during Matching Phase 140, a published price is updated periodically. In some embodiments, the published price is updated each second. As such, an updated price can be different from a price at which a participant sells (hits) a bid or buys (lifts) an offer. In some embodiments, a participant's order is filled at the published price or at a better price. If an updated price for a participant is worse than the price the participant hit or lifted, then the participant will be notified by, for example, a pop-up message informing the participant that the price has adversely changed and asking whether the participant still wants to execute the trade at the updated price. The execution of the trade depends on the participant's answer. If an updated price has changed in favor of a participant, then the participant's order is filled at the more favorable price. During Matching Phase 140, a participant can originate any of the same orders, including swaps and outright orders, that a participant can originate during Breathing Phase 130. In some embodiments, a participant can specify any of the same order constraints available during Breathing Phase 130.

Orders entered during Breathing Phase 130 can have temporal priority over orders entered during Matching Phase 140. Orders entered during Breathing Phase 130 or Matching Phase 140 can be matched according to price/time priority during Matching Phase 140. In price/time priority, price takes priority over time. For example, a buy order for asset A at a higher price will be matched before a buy order for asset A at a lower price. Similarly, a sell order for asset A at a lower price will be matched before a sell order for asset A at a higher price. In some embodiments, if multiple orders on the same side (for example, buy or sell) have the same price, then time takes priority between or among them. In some embodiments, the amount of an order has no priority.

In some embodiments, orders are matched such that both sides of a matched order are substantially simultaneously filled or partially filled according to price/time priority. In some embodiments, orders are matched continuously. In some embodiments, a participant is provided real-time notification of a filled or partially filled order.

In some embodiments, orders are credit-verified. In some embodiments, a credit-verified order is determined by a counter party credit or credit limit.

A participant can increase its odds of being matched if, during Matching Phase 140, it improves its level by, for example, buying at a higher price, lower yield or more aggressive spread or selling at a lower price, higher yield or more aggressive spread.

In some embodiments, during Matching Phase 140, a participant can choose settings that enable it to view anonymous indications of participant interest in an asset, as well as anonymous trade activity in an asset. In some embodiments, other than a participant's own trade activity, the participant cannot view direction (that is, buy or sell), price or amount of an asset in which it has interest or that it has traded.

In some embodiments, during Matching Phase 140, a participant can view in real time the progress of the participant's order as it is filled or partially filled. During Matching Phase 140, a participant can cancel any of its unfilled orders individually or can cancel all of its unfilled orders.

In some embodiments, during Matching Phase 140, an attempt to fill a constrained order (for example, an order with a minimum fill constraint, an order with a minimum increment constraint, a swap or some combination of those constraints) will be made when price and time give the constrained order priority. However, if one or more constraints cannot be satisfied, then an attempt to fill the next prioritized order will be made.

In some embodiments, Matching Phase 140 includes one or more matching time slices. A matching time slice is an interval of time between a time when a matching engine wakes up (that is, commences matching activity) and a time when the matching engine goes to sleep (that is, ceases matching activity). Orders filled during a matching time slice are substantially simultaneously filled according to price/time priority. In some embodiments, there is a look-ahead capability to ensure that all final matches in a matching time slice honor price/time priority.

### Last Call Phase

In some embodiments, Last Call Phase 150 follows Matching Phase 140. In some embodiments, Last Call Phase 150 can be configured based on prior auction activity. For example, in some embodiments, Last Call Phase 150 can include a 30-second batch session, or a batch session of a different duration, as opposed to a continuous session. A batch session is a session in which orders are attempted to be matched and, where possible, matched at the end of the session. In some embodiments, orders are matched in the same way as orders are matched during Matching Phase 140, which is described above. In some embodiments, Last Call Phase 150 involves only assets for which a bad mid was, or bad mids were, calibrated.

In some embodiments, a bad mid exists where there are only offers for an asset through, or off, the mid (that is, above the mid) and no offers below or at the mid, or only bids for an asset through, or off, the mid (that is, below the mid) and no bids above or at the mid. On the other hand, if there has been a trade of an asset at the mid, then the mid is a good mid. The absence of orders for an asset means that there was no participant interest in the asset, but those circumstances do not mean that the mid is a bad mid. In some embodiments, if the Last Call Phase 150 is held because of a bad mid, there is no requirement that part of an order amount be submitted at a corresponding mid.

### Odd Lot Cleanup Phase

In some embodiments, Odd Lot Cleanup Phase 160 follows Matching Phase 140. In embodiments with Last Call Phase 150, Odd Lot Cleanup Phase 160 follows Last Call Phase 150. In some embodiments, mids for Odd Lot Cleanup Phase 160 are the same as the mids published for one or both of Breathing Phase 130 and Matching Phase 140, except that mids for assets which traded during Last Call Phase 150 are the weighted average levels of those trades.

In some embodiments, Odd Lot Cleanup Phase 160 does not include a requirement that part of an order amount be submitted at a corresponding mid. In some embodiments, Odd Lot Cleanup Phase 160 does not allow one or more of a minimum fill constraint, a minimum increment constraint and an order through a mid. In some embodiments, Odd Lot Cleanup Phase 160 does allow an order through a mid.

To further enhance efficiency, a participant can customize a view of assets in order to focus on one or more assets in one or more sectors in one or more upcoming call auctions or phases.

In some embodiments, every auction-related action (for example, contributing a level, entering an order or other action) taken by every participant is logged. Corresponding data is stored in order to address, for example, actual or potential regulatory concerns or trade disputes.

### The Platform

The method described above can be carried out on a platform. The platform can include a group of computers, servers or both, networked together either physically and/or via the internet.

In some embodiments, a participant can access the platform via direct access or sponsored access. Sponsored access means that the participant is interacting with the platform via a third-party sponsor, such as a broker. Sponsored access enables broader platform participation, thereby enhancing dealer/customer relationships. From an end-user perspective, in some embodiments, a participant with sponsored access can access and interact with the platform similarly to, or exactly like, a participant directly accessing and interacting with the platform.

In some embodiments, the platform simultaneously holds auctions for one or more types of assets across one or more sectors. In other embodiments, the platform restricts an auction to one type of asset across one or more sectors. In some embodiments, participants can view, on an Auction Calendar, types of assets, sectors or a combination of types of assets and sectors to be auctioned. In some embodiments, the Auction Calendar can include auctions that repeat on regular intervals (for example, hourly or daily).

In some embodiments, the Auction Calendar includes the current date and time, as well as dates and times of upcoming auctions. In some embodiments, the Auction Calendar includes a count-down clock to a next scheduled or other upcoming auction. In some embodiments, participants are notified on the Auction Calendar when an auction is cancelled. In some embodiments, the Auction Calendar is interactive, allowing participants to gain more knowledge about upcoming auctions, including, but not limited to, particular asset types, sectors or both, that are scheduled to be involved in an auction. In some embodiments, the Auction Calendar has the ability to notify participants of upcoming auctions that include an asset type, such as a U.S. Treasury bond, that the participant owns, in which it has expressed interest or both. In some embodiments, a participant can request that the platform add a particular asset type and/or sector to an upcoming auction. In some embodiments, the platform determines whether to add the participant-requested asset type and/or or sector to an auction based on various factors, including, but not limited to, the number of other participants requesting an auction for the same asset type and/or sector, the time since the asset type and/or sector were last auctioned or some combination thereof.

In some embodiments, the platform can set a period of time during which an auction can be held. In some embodiments, an auction can, for example, be held for 5, 8, 10, 15, 30 or 60 minutes or longer, or even throughout a trading day. In some embodiments, an auction can continue past its set time limit if trading is still taking place or one or more orders have been entered over a certain period of time. For example, in some embodiments the platform can keep an auction open and permit trading for a certain period of time after a trade has occurred. In some embodiments, the platform can cancel an auction before its set time limit has expired. Such cancellation can occur because one or more conditions, such as a lack of trading activity, are satisfied.

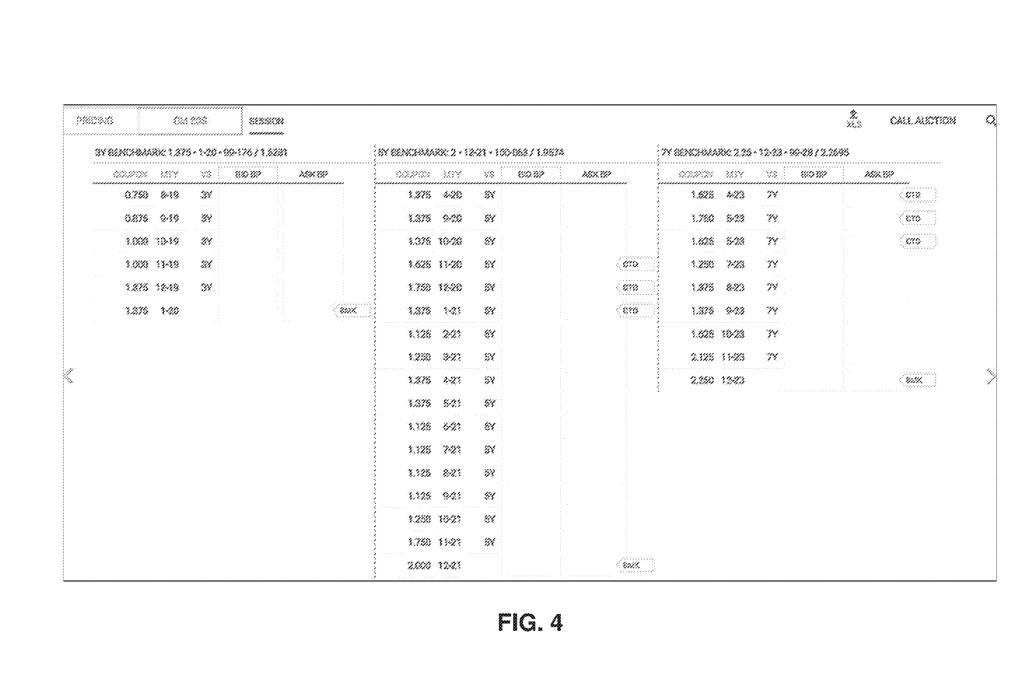

Pricing Phase Menu 400 is illustrated in FIG. 4. In some embodiments, the Pricing Phase 120 lasts 3 minutes, although other durations can be set. In some embodiments, participants can enter prices, or levels, including, but not limited to, levels expressed as yield spreads to the sector benchmark. In some embodiments, participants can enter bids, offers or two-way levels. A two-way level is a bid level to buy and an offer level to sell. In some embodiments, such as the one illustrated in FIG. 4, levels are entered in basis points with 1 decimal place of precision (that is, a tenth of a basis point).

In some embodiments, levels for sector benchmarks are snapped at the beginning of Pricing Phase 120 and remain constant throughout Pricing Phase 120. A sector benchmark level can be referred to as a lock (that is, a single) price or yield. In some embodiments, the lock price of a sector benchmark is displayed in 32nds and to the nearest 32nd. In some embodiments, the lock yield of a sector benchmark is displayed as a percentage with 3 significant digits.

As described above, in some preferred embodiments, a participant is unable to view any level contributed by any other participant during Pricing Phase 120. In some embodiments, the platform can notify a participant if it attempts to contribute an out-of-range level. In some embodiments, a participant can override the notification. In some embodiments, a participant will be notified only once during an auction if any of its submitted levels is out-of-range. A single notification attempts to prevent or dissuade, or prevents or dissuades, the participant from using multiple notifications to attempt to determine the pre-calibrated mid.

In some embodiments, a participant may attempt to game the platform by contributing, or attempting to contribute, one or more levels skewed towards its desired mid. In some embodiments, the platform can detect this attempted gaming, or resulting gaming, and take actions to prevent or mitigate further attempted gaming and gaming by the participant. Such actions include, for example, discarding one or more of a participant's submitted levels. Actions to detect and prevent, or mitigate, attempted gaming and gaming seek to prevent attempted gaming and gaming from interfering with the platform's efficiency and integrity.

In some embodiments, the platform allows participants to import data, including, but not limited to, prices, from various spreadsheet formats, including, but not limited to, Excel and comma-separated values (CSV) formats. In some embodiments, participants can add, change or remove prices until Pricing Phase 120 ends.

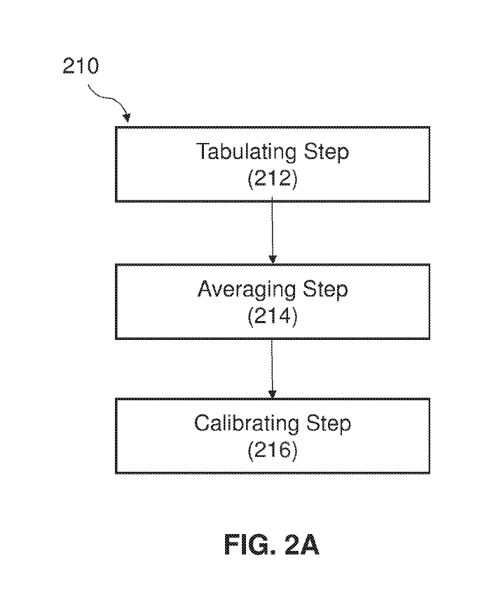

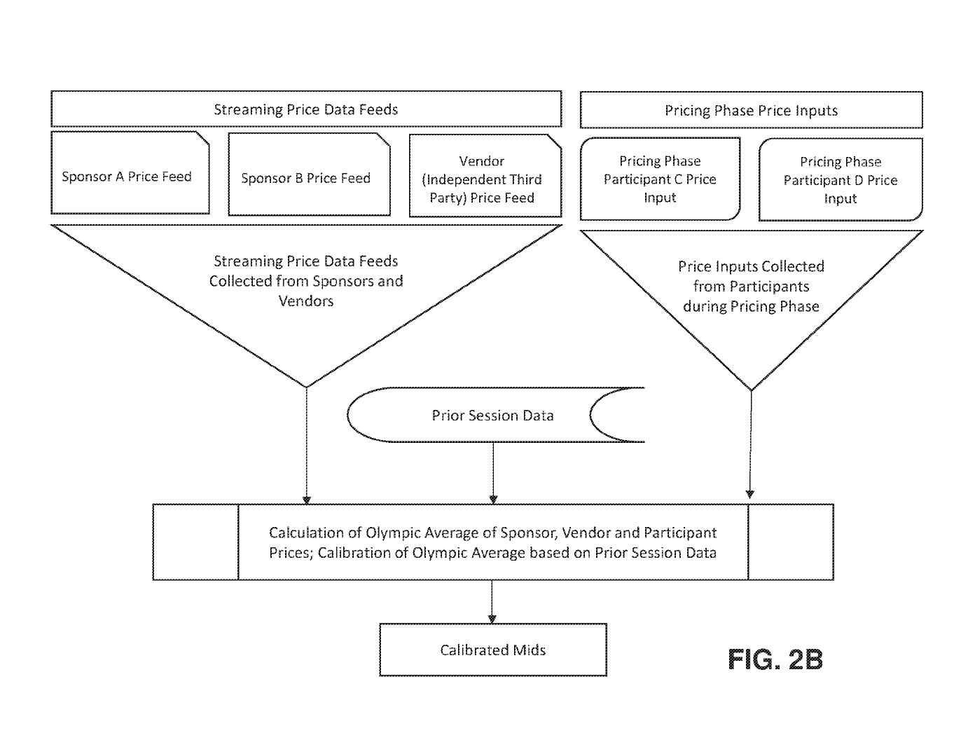

As described above, the platform can calibrate a mid. In some embodiments, Mid-Calibrating Algorithm 210, which is illustrated in FIG. 2A, is used to calibrate a mid. Mid-Calibrating Algorithm 210 includes 3 steps: Tabulating Step 212, Averaging Step 214 and Calibrating Step 216.

FIG. 2B illustrates Mid-Calibrating Algorithm 210 with exemplary pricing data, or price, sources. In some embodiments, Tabulating Step 212 includes collecting prices from one or more of three sources: (1) streaming price data feeds, namely (a) one or more sponsor price feeds and (b) one or more vendor (for example, price data vendor) price feeds and (2) Pricing Phase 120 price inputs from one or more participants. In some embodiments, Averaging Step 214 follows Tabulating Step 212 and includes calculation of an Olympic average of (1) collected price data, or prices, from one or more sponsors and/or one or more price data vendors and/or (2) collected price inputs, or prices, from one or more participants. In some of those embodiments, one or more of (1) prices from sponsors, (2) prices from price data vendors and (3) prices from participants are evaluated and out-of-range prices are discarded prior to Averaging Step 214. In some embodiments, Calibrating Step 216 follows Averaging Step 214 and includes a calibration of the Olympic average based on prior auction, or prior session, data, such as: prior results from one or more auctions; one or more published mids from one or more prior auctions; the volume and the volume-weighted mid of an order imbalance at the end of one or more prior auctions; the volume and the volume-weighted mid of matches from Matching Phase 140 of one or more prior auctions; or various combinations of that data. In some embodiments, the platform can generate a robust, calibrated mid even if no participants contribute prices during Pricing Phase 120. In some preferred embodiments, prices from at least three sponsors are used to calibrate a mid for an asset. In some embodiments, sponsors can submit prices, enter orders or do both.

In some embodiments, prior to Pricing Phase 120, the platform performs an algorithm to calculate, or compute, a pre-calibrated mid. In some embodiments, a pre-calibrated mid is not displayed to any participant. A pre-calibrated mid allows the platform, during Pricing Phase 120, to discard a participant-contributed price that is or may be out-of-range, relative to the pre-calibrated mid, and that a participant may have contributed in an attempt to game the platform. In some embodiments, the platform discards the top X % and bottom X % of participant-contributed prices, where X is configurable or predetermined by the platform. In some embodiments, X is 20%. In some embodiments, where there are a few, or a limited number of, participant-contributed prices, the platform can bypass discarding participant-contributed prices and use the few or limited number of participant-contributed prices to calibrate a mid.

In some embodiments, a pre-calibrated mid is calculated by the identical algorithm used at or near the end of, or after, Pricing Phase 120 or another suitable algorithm. In those embodiments, if no participant contributes a price during Pricing Phase 120, then the pre-calibrated mid and calibrated mid, which is sometimes known as the post-Pricing Phase mid, will be identical. If a participant contributes a price during Pricing Phase 120, then the contributed price, if not discarded, as described above, can be tabulated and used to calibrate the mid.

In some embodiments, there is no commitment by a participant to enter or execute any order (for example, during Breathing Phase 130 or Matching Phase 140) at a price that the participant contributed during Pricing Phase 120.

In some embodiments, the platform publishes a mid to participants after Pricing Phase 120 and at or near the beginning of, or otherwise during, Breathing Phase 130.

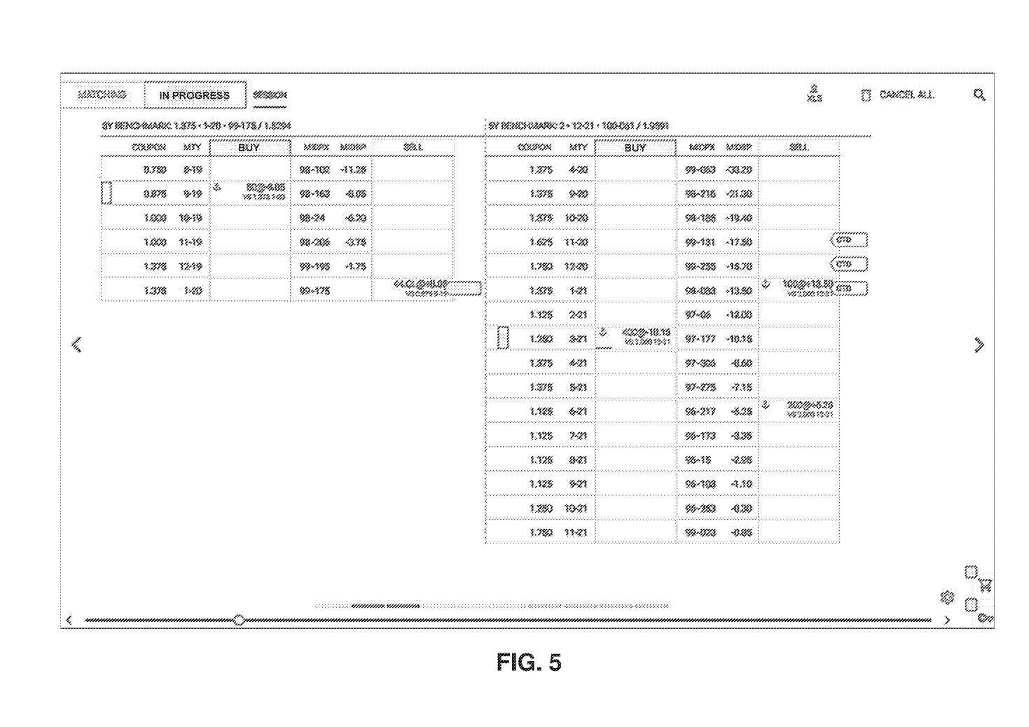

Breathing Phase Menu 500 is illustrated in FIG. 5. In some embodiments, after a mid is calibrated, the calibrated mid is published and viewable by participants and Breathing Phase 130 begins. In some embodiments, Breathing Phase 130 lasts 2 minutes, although other durations can be set. In some embodiments, Breathing Phase Menu 500 includes a count-down clock showing when Breathing Phase 130 ends. In some embodiments, a single price or yield for the sector benchmark is snapped at the beginning of Breathing Phase 130 and remains constant until the end of Breathing Phase 130.

In some embodiments, Breathing Phase Menu 500 contains an amount of credit a participant has. In some embodiments, submitting an order during Breathing Phase 130 does not affect a participant's credit.

During Breathing Phase 130, a participant can enter an order and, in some embodiments, can do so through Breathing Phase Menu 500. In some embodiments, no attempt to match orders is made during Breathing Phase 130. In some embodiments, each order is assigned a unique, random time-stamp, as described above.

In some embodiments, Breathing Phase Menu 500 can highlight an asset, such as a U.S. Treasury bond, for which a participant contributed a price during Pricing Phase 120. In some embodiments, Breathing Phase Menu 500 can display how a participant's contributed price compares to the calibrated mid.

In some embodiments, a participant can indicate a minimum fill and/or minimum increment it would accept in buying or selling an asset. In some embodiments, if the minimum fill, minimum increment or both are left blank, the platform automatically assigns to each criterion a configurable or predetermined amount. In some embodiments, the platform allows participants to import data, including order data, from various spreadsheet formats, including, but not limited to, Excel and CSV formats.

In some embodiments, a participant can enter a swap through Breathing Phase Menu 500.

In some embodiments, orders entered during Breathing Phase 130 are substantially simultaneously submitted at or near the outset of Matching Phase 140.

In some embodiments, the platform's matching engine enforces price/time priority. In those embodiments, a participant might improve its level, by a trivial amount, in order to attempt to increase, or increase, its odds of being matched. Such a trivial improvement, whether an increase or decrease in price, is known as pennying.

Some embodiments of the platform include mining data from one or more prior and/or current auctions, and taking action to prevent a participant from attempting to game, or gaming, the platform through, for example, pennying. In some embodiments, one or more different rules against pennying, such as configurable or predetermined tolerances, can be applied to one or more asset types and/or sectors.

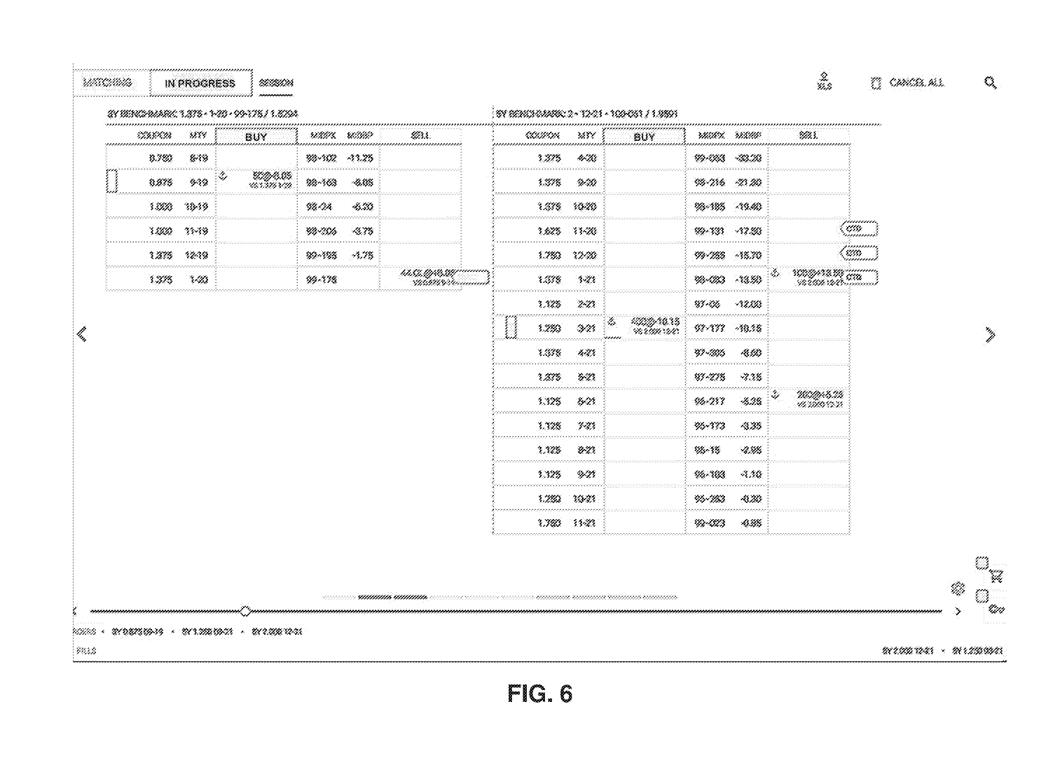

FIG. 6 illustrates Matching Phase Menu 600. In some embodiments, Matching Phase 140 is a continuous matching session during which a participant receives real-time notification of its filled or partially filled orders, but no indication of what any other participant has traded or the state of any other participant's order book. In other embodiments, Matching Phase 140 is a batch session.

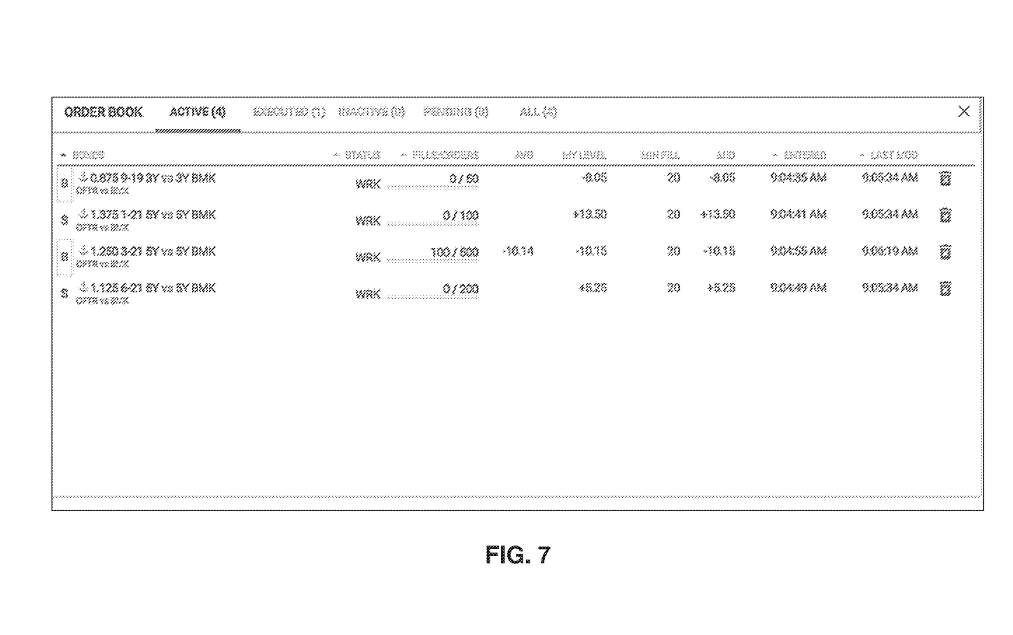

In some embodiments, after orders entered during Breathing Phase 130 are entered into an order book, the platform's matching engine attempts to match the orders during Matching Phase 140. In some embodiments, Matching Phase 140 lasts for 3 minutes or until trading activity has abated to a configurable or predetermined rate. In some embodiments, trading activity rate is calculated by measuring the number of completed trades or entered orders over a certain period of time. In some embodiments, trading activity has abated to a configurable or predetermined rate where there are no completed trades or entered orders over a certain period of time. In some embodiments, the platform uses and displays a clock to count-down the time in Matching Phase 140, regardless of the number of trades completed or orders entered. In some embodiments, the clock is set to 30 seconds. In some embodiments, Matching Phase Menu 600 can include an Order Book 700, such as the one illustrated in FIG. 7, which can display, among other things, an order a participant has entered.

In some embodiments, if a participant changes its order criteria, including a constraint, it loses its time priority in an order stack. In some embodiments, a participant is provided real-time notification of its filled or partially filled orders on Matching Phase Menu 600.

During Matching Phase 140, the platform's matching engine can identify one or more market gaps, generate one or more KeyChain orders to fill one or more of the one or more market gaps and form a KeyChain, as described above.

In some embodiments, the matching engine performs credit checks prior to matching two orders. In some embodiments, a sponsor can assign a credit limit to each of its sponsored client firms and each client firm can assign a credit limit to each of its traders. In some embodiments, the sum of traders' limits can exceed the credit limit the sponsor has assigned that client firm, but the smaller limit (that is, the credit limit the sponsor assigned to its client firm) is enforced. In some embodiments, credit limits are defined across the entire platform. In some embodiments, the platform evaluates and enforces a set of criteria, such as trading limits, counterparty credit limits and risk limits, entered by one or more of a sponsor, sponsored end-user and platform administrator. In some embodiments, credit is checked at or near the time of order entry. In other embodiments, credit is not checked at or near the time of order entry, but, rather, at or near the time of attempted matching. In some embodiments, an order is filled up to a credit limit, a participant is sent a notice as to the filled or partially filled order, and a remaining or partially remaining order is cancelled. In some embodiments, a sponsor can prioritize a client firm's credit limit.

In some embodiments, the platform allows one or more of the same types of orders as the above-described method.

In some embodiments of the platform, price always takes priority. If there are multiple orders at the same price, time takes priority between or among them. In some embodiments, amount, or size, of an order has no priority because a size of an order can be relatively easily gamed. Therefore, time trumps size, and price trumps time. The platform attempts to fill a constrained order (for example, an order with a minimum fill constraint, a minimum increment constraint, a swap, or some combination of those constraints) when price and time give it priority. However, if one or more constraints cannot be satisfied, then the platform attempts to fill the next prioritized order.

As described above, Matching Phase 140 can be a continuous match session during which the matching engine attempts to match as many orders as possible. The matching engine goes to sleep when it has matched everything it can. The matching engine does not wake up until a new order enters an order book or a new level for a benchmark is snapped.

At or near the outset of Matching Phase 140, there can be a mini batch auction that takes place before continuous attempted matching and matching begins, but the same matching rules can be in effect for all of Matching Phase 140.

In some embodiments, Matching Phase 140 includes one or more matching time slices. Orders that the matching engine fills during a matching time slice can be filled substantially simultaneously according to price/time priority. Each successive matching time slice, however, has its own time-stamp. Within a matching time slice, the matching engine can look ahead, without regard to time priority, so long as the final results from that matching time slice honor price/time priority.

During a matching time slice, a participant's order can be matched multiple times, meaning matched by multiple orders, each of which matches a portion of a participant's order, according to, for example, a minimum fill constraint, a minimum increment constraint or a certain level. In some embodiments, there can be size-based starvation (for example, a large order with time priority can starve out other orders at the same price). This potential issue can be overcome if a participant improves its price.

In some embodiments, a participant's order can be filled or partially filled by two or more orders at different prices. In the same or some embodiments, at or after the end of Matching Phase 140, the two or more orders for the same asset are aggregated into a single trade at an average price.

In some embodiments, the platform sends a trade ticket to a participant at or after the end of Matching Phase 140. A trade ticket itemizes a participant's trade activity at, for example, the end of Matching Phase 140.

The platform may produce a bad mid for one or more assets. Under such circumstances, in some embodiments, a Last Call Phase Menu can be displayed and used. In some embodiments, Last Call Phase 150 lasts 30 seconds, although other durations can be set. In some embodiments, Last Call Phase 150 is a batch auction and follows the same matching algorithm as Matching Phase 140, with the exception that the platform's matching engine does not run until the end of Last Call Phase 150. At or after the end of Last Call Phase 150, a participant's filled orders (that is, the portions of the orders filled) for the same asset are aggregated into a single trade at an average price.

In some embodiments, Odd Lot Cleanup Phase 160, which can display and use Odd Lot Cleanup Phase Menu, follows Last Call Phase 150. If there is not a Last Call Phase 150, then Odd Lot Cleanup Phase 160 follows Matching Phase 140. In some embodiments, this is no minimum fill or minimum increment constraint during Odd Lot Cleanup Phase 160. In some embodiments, Odd Lot Cleanup Phase 160 uses the same matching algorithm as Matching Phase 140. In some embodiments, at or after the end of Odd Lot Cleanup Phase 160, a participant's filled orders for the same asset are aggregated into a single trade at an average price. In some embodiments, if a participant traded the same asset in both Matching Phase 140 and Odd Lot Cleanup Phase 160, then the filled orders can be aggregated into a single trade at an average price. In some embodiments, entering orders through the mid is not allowed in Odd Lot Cleanup Phase 160.

In some embodiments, Post-Trade Phase 170, which can display and use a Post-Trade Phase Menu, follows one or more of Odd Lot Cleanup Phase 160, Last Call Phase 150 and Matching Phase 140. In some embodiments, Post-Trade Phase Menu displays, for example, one or more of individual fills, aggregated trades at average prices, fees, accrued interest, settlement amounts, session duration, trades not filled and duration-weighted amounts of second or hedged assets. In some embodiments, Post-Trade Phase Menu also displays a count-down clock to a next scheduled or upcoming auction. In some embodiments, the count-down clock is for a particular asset type or sector. In some embodiments, Post-Trade Phase Menu allows participants to download auction results into a file in, for example, CSV format.

In some embodiments, the platform includes an OTR-only auction. An OTR-only auction is an auction separate from an auction that includes OFTRs, TIPS or both OFTRs and TIPS. The only assets in an OTR-only auction are one or more of the six OTRs, namely, 2-year, 3-year, 5-year, 7-year, 10-year and 30-year OTR's. In an OTR-only auction, there can be outright OTR orders and OTR swaps, namely, OTR to OTR swaps, which are also known as yield curve swaps. In some OTR-only auctions, there may be no Pricing Phase 120. In some OTR-only auctions, each published mid may be the Olympic average of sponsor-fed prices. In some OTR-only auctions, each published mid may be the yield spread between the mid yields of two assets. In some OTR-only auctions, a published mid is updated every second or at another configurable or predetermined interval. In some OTR-only auctions, there is a minimum order size. In some OTR-only auctions, a minimum fill constraint is allowed. In an OTR-only auction, a minimum increment constraint is not allowed. In an OTR-only auction involving two or more orders, where one or more orders are outright OTR orders and/or one or more orders are OTR to OTR swaps, a KeyChain can be formed, as described above.

In some embodiments, the platform logs every auction-related action taken by every participant and stores corresponding data for the reasons described above.

The above-described embodiments can be employed individually or in various suitable combinations. One or more identified steps or components can be excluded and/or one or more additional steps or components can be added without departing from the scope of the present disclosure.

While particular elements, embodiments and applications of the present invention have been shown and described, it is and will be understood that the invention is not limited thereto since one or more modifications can be made without departing from the scope of the present disclosure, particularly in light of the foregoing teachings.

What is claimed is:

1. A computer-implemented method for an anonymous, multi-phase, call auction of at least one asset, the method comprising:
(a) initiating the auction for the at least one asset;
(b) conducting a pricing phase for a first period of time;
(c) calculating and publishing at least one calibrated mid-price curve for the at least one asset;
(d) conducting a breathing phase for a second period of time, during which one or more participants can evaluate the at least one calibrated mid-price curve;
(e) conducting a matching phase for a third period of time;
(f) receiving at least one buy order and at least one sell order; and
(g) attempting to match one or more of the at least one buy order and one or more of the at least one sell order.

2. The method of claim 1, further comprising anonymously matching and at least partially filling one or more of the at least one buy order and one or more of the at least one sell order.

3. The method of claim 1, further comprising:
(h) during the matching phase, identifying one or more market gaps between or among two or more orders;
(i) generating one or more KeyChain orders to fill one or more of the one or more market gaps;
(j) forming a KeyChain of three or more orders, where one or more of the orders are the one or more KeyChain orders and two or more of the orders are participant-entered orders; and
(k) at least partially filling an amount of each of the three or more orders in the KeyChain, thereby completing the KeyChain.

4. The method of claim 1, further comprising:
(h) calculating and publishing at least one pre-calibrated mid-price curve for the at least one asset.

5. The method of claim 1, wherein the at least one buy order and the at least one sell order are entered during the breathing phase and each order is assigned a unique, random time-stamp at or near the end of the breathing phase.

6. The method of claim 4, wherein the at least one buy order and the at least one sell order are submitted substantially simultaneously at or near the outset of the matching phase.

7. The method of claim 5, wherein the at least one asset comprises one from the group of U.S. Treasuries and other bonds.

8. The method of claim 7, wherein the at least one asset spans multiple sectors.

9. The method of claim 5, wherein the matching phase lasts for at least 3 minutes and ends 30 seconds after a last new order is entered.

10. The method of claim 5, further comprising:
(h) a last call phase.

11. The method of claim 5, further comprising:
(h) an odd lot cleanup phase.

12. The method of claim 5, wherein pennying by one or more participants is mitigated.

13. The method of claim 1, wherein the pricing phase includes:
(i) evaluating and
(ii) accepting or rejecting a level that a participant contributes to calibrate the calibrated mid-price curve.

14. The method of claim 1, wherein any order entered is prioritized based on price/time priority.

15. The method of claim 1, wherein the matching phase involves performing a credit check on a participant prior to matching any order entered by the participant.

16. The method of claim 1, wherein orders are attempted to be matched continuously during the matching phase and a notification of an at least partially filled order is provided in real-time to each corresponding participant.

17. The method of claim 1, wherein each order is filled at a displayed price or at an updated price more favorable to the participant that entered the order.

18. The method of claim 1, further comprising:
(h) determining whether there is sufficient participant interest for the auction of the at least one asset.

19. The method of claim 1, wherein the auction is all-to-all.

20. A computer-implemented method for an anonymous, multi-phase, call auction of at least one non-financial asset, the method comprising:
(a) initiating the auction for the at least one asset;
(b) conducting a pricing phase for a first period of time;
(c) calculating and publishing at least one calibrated mid for the at least one asset;
(d) conducting a breathing phase for a second period of time, during which one or more participants can evaluate the at least one calibrated mid;
(e) conducting a matching phase for a third period of time;
(f) receiving at least one buy order and at least one sell order; and
(g) attempting to match one or more of the at least one buy order and one or more of the at least one sell order.

21. The method of claim 20, further comprising anonymously matching and at least partially filling one or more of the at least one buy order and one or more of the at least one sell order.

22. The method of claim 20, further comprising:
(h) during the matching phase, identifying one or more market gaps between or among two or more orders;
(i) generating one or more KeyChain orders to fill one or more of the one or more market gaps;
(j) forming a KeyChain of three or more orders, where one or more of the orders are the one or more KeyChain orders and two or more of the orders are participant-entered orders; and
(k) at least partially filling an amount of each of the three or more orders in the KeyChain, thereby completing the KeyChain.

23. The method of claim 20, wherein the at least one non-financial asset is at least one of artwork, jewelry, a vehicle, currency, furniture, ceramic, clothing, an event ticket or a collectable item.

24. The method of claim 23, wherein the collectable item is a sports card.

25. The method of claim 23, wherein the collectable item is an autograph.
